(19) United States
(12) Patent Application Publication
(10) Pub. No.: US 2020/0250525 A1
(43) Pub. Date: Aug. 6, 2020

(54) LIGHTWEIGHT, HIGHSPEED AND ENERGY EFFICIENT ASYNCHRONOUS AND FILE SYSTEM-BASED AI PROCESSING INTERFACE FRAMEWORK

(71) Applicant: Pathtronic Inc., San Francisco, CA (US)

(72) Inventors: Sateesh Kumar Addepalli, San Jose, CA (US); Vinayaka Jyothi, Sunnyvale, CA (US); Ashik Hoovayya Poojari, Sunnyvale, CA (US)

(21) Appl. No.: 16/528,551

(22) Filed: Jul. 31, 2019

Related U.S. Application Data
(60) Provisional application No. 62/801,050, filed on Feb. 4, 2019.

(51) Int. Cl. G06N 3/08; G06N 3/04; G06K 9/62; G06N 5/04

(52) U.S. Cl. CPC G06N 3/08; G06N 5/04; G06K 9/6256; G06N 3/0454

(57) ABSTRACT

Aspects of the disclosure are presented for an elegant mechanism to allow for AI training using an AI system that is platform agnostic and eliminates the need for multi processors, e.g., CPU, VMs, OS & GPU based full stack software AI frameworks. The AI system may utilize an asynchronous or file system interface, allowing for a send/drop interface of an input data file to automatically run training or inference of an AI solution model. Existing AI solutions would require multi machine learning, deep learning frameworks, and/or one or more SDKs to run to run on CPU, GPU and accelerator environments. The present disclosures utilize special AI hardware that does not rely on such conventional implementations.

### CROSS REFERENCE TO RELATED APPLICATION

This application claims priority to U.S. Provisional Application No. 62/801,050, filed Feb. 4, 2019, and titled LIGHTWEIGHT, HIGHSPEED AND ENERGY EFFICIENT ASYNCHRONOUS AND FILE SYSTEM-BASED AI PROCESSING INTERFACE FRAMEWORK, the disclosure of which is hereby incorporated herein in its entirety and for all purposes.

### TECHNICAL FIELD

The subject matter disclosed herein generally relates to artificial intelligence. More specifically, the present disclosures relate to methods and systems for asynchronous and file system-based AI processing interfaces.

### BACKGROUND

Today, AI training and inference techniques are cumbersome, in the sense that they require extensive hardware and software support in order to run AI solution models. For example, a CPU, AI framework, AI accelerator and appropriate glue logic are needed to run AI training and inference techniques, typically. Going forward in the edge/mist environments where CPU and software framework is a luxury, it is going to be a big penalty to run AI training and inference with ease using traditional methods. It is desirable therefore to develop new hardware frameworks for AI processing that are efficient and may be optimized toward AI processing.

### BRIEF DESCRIPTION OF THE DRAWINGS

Some embodiments are illustrated by way of example and not limitation in the figures of the accompanying drawings.

FIG. 1 is a diagram of an AI system lane comprising energy efficient hyper parallel and pipelined temporal and spatial scalable artificial intelligence (AI) hardware with minimized external memory access, in accordance with at least one aspect of the present disclosure.

FIG. 2 is a diagram of a secure re-configurable AI compute engine block with no traditional software overhead during model execution (inference or training) for speed and efficiency, in accordance with at least one aspect of the present disclosure.

FIG. 3 is a diagram of a virtual AI system lane created to execute, training and inference, in accordance with at least one aspect of the present disclosure.

FIG. 4 is a diagram of a virtual AI system multilane, in accordance with at least one aspect of the present disclosure.

FIG. 5 is a diagram of a virtual AI system multilane comprising a data fuser, in accordance with at least one aspect of the present disclosure.

FIG. 6 is a diagram of a virtual AI system multilane comprising an uber hardware orchestrator, in accordance with at least one aspect of the present disclosure.

FIG. 7A shows a functional block diagram of an AI system with connections to host users in an example of the AI processing framework interface, according to some embodiments.

FIG. 7B shows an additional viewpoint of particular modules of the asynchronous AI interface system, according to some embodiments.

FIG. 8 is a chart providing a number of examples of machine learning applications.

FIG. 9 shows an example of how the execution stacks for GPUs and CPUs connect to applications to perform machine learning.

FIG. 10 shows a diagram of the elegant design architecture of the AI system of the present disclosure, utilizing a network structure that connects to the RER interface and the file system view of the user or host.

FIG. 11 shows the stack execution flow in typical GPU based systems that may be contrasted with the more efficient design of the present disclosures.

FIG. 12 shows the process flow of the RER unit of the AI system of the present disclosures, according to some embodiments.

FIG. 13 describes an example of the chain of operation by the uber-orchestrator, according to some embodiments.

FIG. 14 shows an example of the pipelining and parallelizing of the execution flow by the uber orchestrator, according to some embodiments.

FIGS. 15A and 15B show a visualization of 25 instances of a pipelining AI operation running in parallel using all available lanes of an AI system, according to some embodiments.

FIG. 16 provides an example of some lanes in an AI multilane system that are sitting idle while other lanes are conducting a pipelining AI operation running in parallel with other operations, according to some embodiments.

FIG. 17 shows further details inside the uber orchestrator, according to some aspects.

FIG. 18 shows further details inside the orchestrator, according to some aspects.

### DETAILED DESCRIPTION

Applicant of the present application owns the following U.S. Provisional Patent Applications, all filed on Feb. 4, 2019, the disclosure of each of which is herein incorporated by reference in its entirety:
U.S. Provisional Application No. 62/801,044, titled SYSTEMS AND METHODS OF SECURITY FOR TRUSTED AI HARDWARE PROCESSING;
U.S. Provisional Application No. 62/801,046, titled SYSTEMS AND METHODS FOR ARTIFICIAL INTELLIGENCE HARDWARE PROCESSING;
U.S. Provisional Application No. 62/801,048, titled SYSTEMS AND METHODS FOR ARTIFICIAL INTELLIGENCE WITH FLEXIBLE HARDWARE PROCESSING FRAMEWORK;
U.S. Provisional Application No. 62/801,049, titled SYSTEMS AND METHODS FOR CONTINUOUS AND REAL-TIME AI ADAPTIVE SENSE LEARNING;
U.S. Provisional Application No. 62/801,051, titled SYSTEMS AND METHODS FOR POWER MANAGEMENT OF HARDWARE UTILIZING VIRTUAL MULTILANE ARCHITECTURE.

Applicant of the present application also owns the following U.S. Non-Provisional Patent Applications, filed herewith, the disclosure of each of which is herein incorporated by reference in its entirety:
Attorney Docket No. 1403394.00003, titled SYSTEMS AND METHODS OF SECURITY FOR TRUSTED AI HARDWARE PROCESSING;
Attorney Docket No. 1403394.00006, titled SYSTEMS AND METHODS FOR ARTIFICIAL INTELLIGENCE HARDWARE PROCESSING;
Attorney Docket No. 1403394.00009, titled SYSTEMS AND METHODS FOR ARTIFICIAL INTELLIGENCE WITH A FLEXIBLE HARDWARE PROCESSING FRAMEWORK;
Attorney Docket No. 1403394.00012, titled SYSTEMS AND METHODS FOR CONTINUOUS AND REAL-TIME AI ADAPTIVE SENSE LEARNING; and
Attorney Docket No. 1403394.00018, titled SYSTEMS AND METHODS FOR POWER MANAGEMENT OF HARDWARE UTILIZING VIRTUAL MULTILANE ARCHITECTURE.

Aspects of the disclosure are presented for an elegant mechanism to allow for AI training involving an AI system like those described in Provisional Applications (Attorney Docket No. Set 1/1403394.00002, U.S. Provisional Application No. 62/801,044, Attorney Docket No. Set 2/1403394.0005, U.S. Provisional Application No. 62/801,046, and Attorney Docket No. Set 3/1403394.0008) U.S. Provisional Application No. 62/801,048, can be exposed to be made available to act as an SD card or similar file storage system module/card with a file system, making it easier for users to drag and drop specified models and associated configuration and training/inference data, and automatically receive results in the form of a result file. Starting and stopping of training can be as simple as having a trigger file or trigger button (soft or hard).

The embodiments described herein eliminate multi processors/CPU, VMs, OS & GPU based full stack software AI frameworks intervention such that inference and training is self-contained and real-time without any interruption or overhead associated with traditional AI accelerators working in conjunction with full stack software AI frameworks.

In some embodiments, a method is presented in which a virtualized multilane parallel hardware secure multi-functional AI app solution compute engine is exposed as an asynchronous or file system interface, wherein a user/machine can send/drop in an input data file, such as a configuration file, training data files, trigger files, etc., to automatically run training or inference of an AI solution model. The AI solution model may be an AI model output that solves a problem or a request made by a user. For example, an AI solution model may be the output by the AI system based on the user having requested of the AI system to generate a model that, when performed by the AI system, organizes images into various categories after being trained on a set of training data.

In some embodiments, an apparatus within the AI system is presented that looks for the input data files, such as a configuration file (security and model related configuration data), training data files, or trigger data files. Once all the required files are visible to the apparatus, it automatically directs the control circuit, such as an orchestrator module, to configure and start an AI processing chain and waits for the results from the orchestrator. Once results are available, the orchestrator may prepare a result file and makes it visible to the file system along with appropriate triggers to the host system.

The disclosures herein provide unique and more efficient solutions to train AI solution models. Current approaches use multi processors/CPU, VMs, OS & GPU based full stack software AI frameworks, and the like, for inference and training with interruptions or overhead associated with AI accelerators working in conjunction with full stack software AI frameworks. Existing AI solutions would require multi machine learning, deep learning frameworks, and/or one or more SDKs to run to run on CPU, GPU and accelerator environments. The present disclosures utilize special AI hardware that does not rely on such conventional implementations.

Discussion of Overall System

Provisional applications Attorney Docket No. Set 2/1403394.00005 U.S. Provisional Application No. 62/801,046, titled SYSTEMS AND METHODS FOR ARTIFICIAL INTELLIGENCE HARDWARE PROCESSING; and Attorney Docket No. Set 3/1403394.00008, U.S. Provisional Application No. 62/801,048, titled SYSTEMS AND METHODS FOR ARTIFICIAL INTELLIGENCE WITH FLEXIBLE HARDWARE PROCESSING FRAMEWORK; which are again incorporated herein by reference, describe further details about the structure and functional blocks of an AI system of the present disclosures.

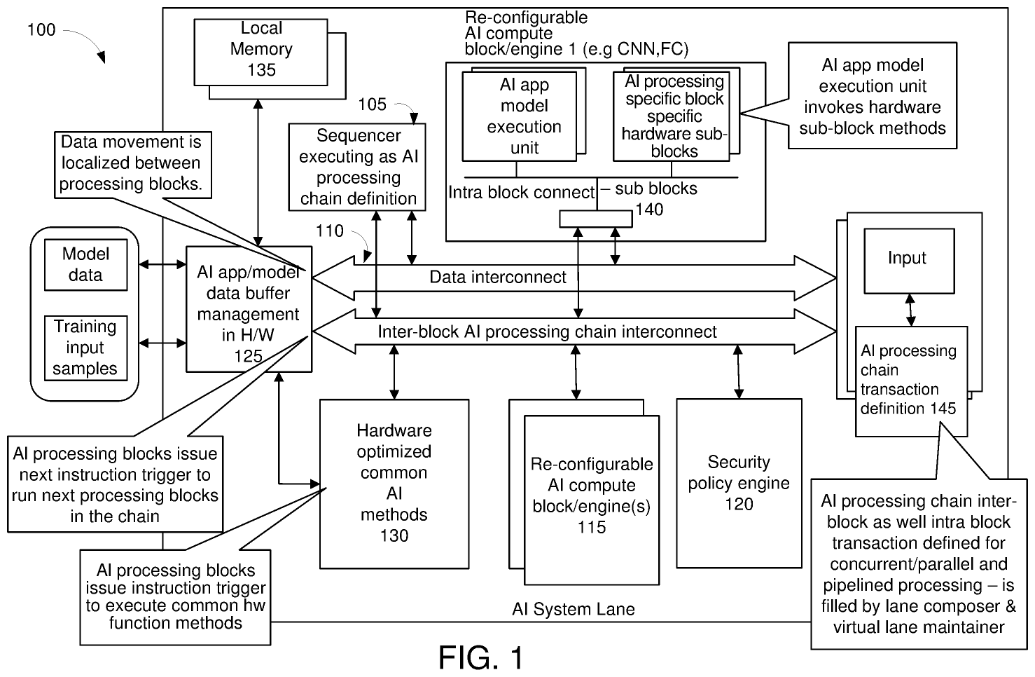

For example, FIG. 1 is a diagram 100 of an AI system lane comprising energy efficient hyper parallel and pipelined temporal and spatial scalable artificial intelligence (AI) hardware with minimized external memory access, in accordance with at least one aspect of the present disclosure. An AI system lane is an integrated secure AI processing hardware framework with an amalgamation of hyper-parallel-pipelined (HPP) AI compute engines interlinked by data interconnect busses with a hardware sequencer 105 to oversee AI compute chain execution. The execution flow is orchestrated by the sequencer 105 by using an AI processing chain flow. The blocks within the AI system lane are interconnected by high bandwidth links, e.g., data interconnects 110 and inter-block AI processing chain interconnects, to transfer the output between each other. Therefore, one or more AI compute engines can run in parallel/pipeline to process the AI algorithm.

In various aspects, an AI system lane comprises eight major blocks, such as re-configurable AI compute engine blocks 115, interconnects 110, a sequencer 105, common method processing blocks 130, local memory 135, security policy engine block 120, AI application data management buffer 125, intra block connect sub blocks 140, etc. All the modules work together to solve the task assigned to the AI system lane.

In one aspect, the AI system lane comprises re-configurable AI compute engines/blocks hardware 115. The re-configurable AI compute engines/blocks hardware is an AI system integrated high performance and highly efficient engine. The re-configurable AI compute engines/blocks hardware computes the AI methods assigned by the sequencer 105. The sequencer 105 is comprised of a state machine with one or more configurable AI-PLUs to process the AI application/model. The sequencer 105 maintains a configurable AI-PLU to compute different type of methods. Due to the configurable nature of the hardware, utilization is very high. Hence, a high throughput is achieved at a low clock frequency and the process is very energy efficient. In case of secure processing, it also contains one or more S-PLUs to process security related features and consequently provide iron clad security to the AI system lane as well as enabling a wide range of AI driven security applications. The re-configurable AI compute engine blocks 115 eliminate the need for an operating system and AI software framework during the processing of AI functions.

In one aspect, the AI system lane comprises local memory 135. The local memory 135 may be a high speed memory interfaced to the AI application data management hardware 125. It has the data, the layer results, weights, and inputs required by the AI system lane to execute.

In one aspect, the AI system lane comprises a common method processing block 130. The common method processing block 130 contains the hardware to process common functions. For example, encrypting the output, etc.

In one aspect, the AI system lane comprises an AI application data management buffer block 125. The AI application data management buffer block manages the memory requirement between the blocks. It also maintains the data transfer between the global memory and local memory.

In one aspect, the AI system lane comprises data and AI processing chain interconnects 110. All the blocks are connected by the data interconnect bus and an inter-block AI processing chain interconnect bus. The data interconnect bus transfers data within the engines and transfers to local memory. The inter-block AI processing chain interconnect bus carries all the control information. Control blocks include, for example, application buffer management H/W, sequencer, and instruction trigger modules. Data movement is localized within the blocks. The data interconnect bus has higher bandwidth when compared to the inter-block AI processing chain interconnect.

In one aspect, the AI system lane comprises a security policy engine 120. The security policy engine safeguards the AI system lanes from security attacks (virus/worms, intrusions, denial of service (DoS), theft). The security policy engine directs enforcement of all the security features required to make the execution of the model secure on the compute block/engine. Additional details of trust and security built into the AI system are found in commonly owned Application Attorney Docket No. Set 1/1403394.00002 U.S. Provisional Application No. 62/801,044, titled SYSTEMS AND METHODS OF SECURITY FOR TRUSTED AI HARDWARE PROCESSING, filed on Feb. 4, 2019, which is incorporated herein by reference in its entirety.

In one aspect, the AI system lane comprises a sequencer 105. The sequencer directs AI chain execution flow as per the inter-block and intra-block transaction definition 145. An AI system lane composer and virtual lane maintainer provides the required definition. The sequencer 105 maintains a queue and a status table. The queue contains model identification (ID), type of methods and configuration data for the layer(s). The model ID differentiates the model being executed. The methods inform the sequencer the type of re-configurable AI compute engine blocks to use. Configuration data contains the macro parameters that are required by the engines to execute the model properly. The status table contains the status of all the AI processing blocks. The table maintenance is active whether the AI processing block is busy or idle. All the operations will be queued by the lane orchestrator in the sequencer 105. The sequencer will trigger the operation from the queue depending on the available AI-PLU block which is idle. Once an operation is completed by the AI-PLU block, the sequencer 105 will change the corresponding entry to idle in the status table and reports it to the lane orchestrator about the completion. The lane orchestrator will now ask the AI system lane for the transfer of the output if all the tasks related to the input with respect to the model are completed.

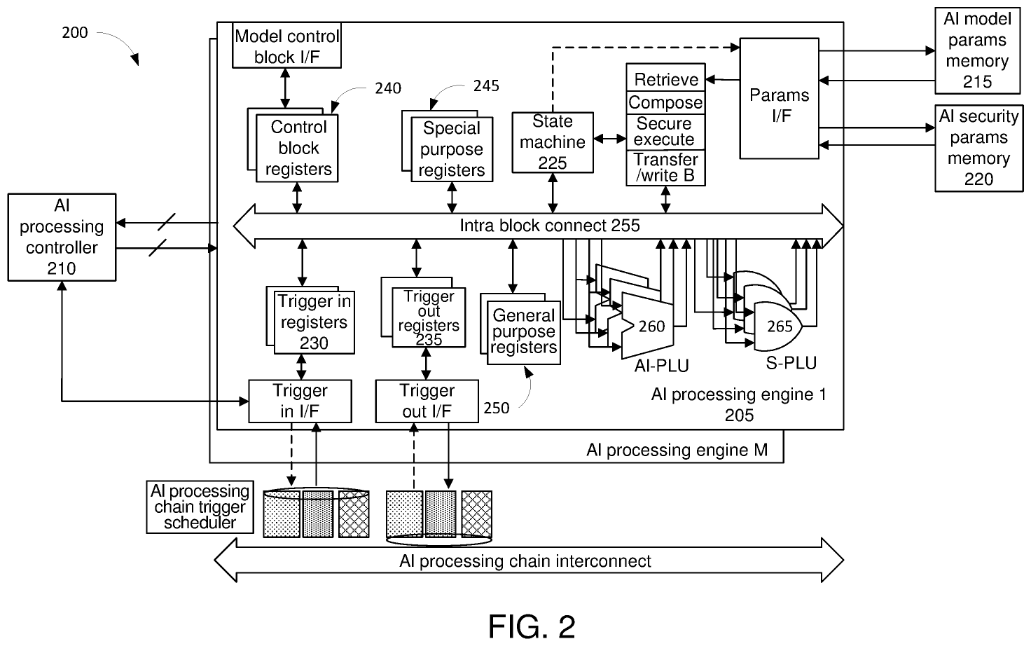

FIG. 2 is a diagram 200 of a secure re-configurable AI compute engine block 115 (see e.g., FIG. 1) with no traditional software overhead during model execution (inference or training) for speed and efficiency, in accordance with at least one aspect of the present disclosure. As used herein, the secure re-configurable AI compute engine block 115 comprises at least one AI processing engine 205 (shown here are multiple engines 1 through M), an AI processing controller 210 coupled to the processing engine(s) 205, an AI solution model parameters memory 215 coupled to the processing engine(s) 205, and an AI security parameters memory 220 coupled to the processing engine(s) (205. The processing engine comprises a state machine 225, trigger in/out registers 230 and 235, a control register 240, a special purpose register 245, a general purpose register 250, and an intra block connect bus 255 for communication and control between the registers 230, 235, 245, 250, control blocks 240, and state machine 225. The processing engine also comprises AI processing logic units (AI-PLUs) 260 and security processing logic unit (S-PLUs) 265 coupled to the intra block connect bus 255.

In one aspect, the AI compute engine block 115 comprises a plurality of processing engines 205 configured to trigger the state machine 225 for different memory and control transactions. The AI compute engine block 115 manages the chain of triggers required to complete a subsequent layer and also manages the memory transaction triggers. Control transaction includes triggering the state machine 225 corresponding to the method, software resetting the processing engine, etc. The compute engine block 115 also manages the memory triggers triggered by the state machine 225 such as write or read. The memory master, which resides outside of the AI compute engine block 115, will trigger the state machine 225 once the memory transaction triggered by the state machine 225 is completed. So all the combination of AI method trigger, memory transaction trigger, and software reset is managed by the trigger in/out registers 230 and 235.

In one aspect, the AI compute engine block processing engine(s) 205 comprises AI processing logic units (AI-PLUs) 260. Each of the AI-PLUs contains a set of multiplier, comparators and adders functional units. This fabric of functional units can be configured by the AI parameters to process AI methods such as CNN forward/backward, fully connected (FC) forward/backward, max-pooling, un-pooling, etc. This configuration is dependent on the dimensions of the model, type of the AI method and memory width (number of vector inputs that can be fetched at a single clock). The AI-PLU(s) 260 can process wide vectors at a single clock in a pipelined configuration. Hence it has high performance and is energy efficient.

In one aspect, the AI compute engine block processing engine(s) 205 comprises security processing logic units (S-PLUs) 265. Each of the S-PLUs contains a set of cryptographic primitives such as hash functions, encrypt/decrypt blocks, arranged in parallel and pipelined configuration to implement various security/trust functions. This fabric of functional units can be configured with the security parameters to process certain security features. These configurations are directed by the security policy engine. It can process wide security processing vectors at a single clock in a pipelined configuration. Hence, it has high performance and is energy efficient. In addition to protecting the AI application/solution models, S-PLUs in conjunction with AI-PLUs and other security and trust features built on to the AI system can run AI driven security applications for a range of use cases and markets.

In one aspect, the AI compute engine block processing engine(s) 205 comprises a state machine 225. The state machine 225 is the brain of the AI compute engine block. The state machine 225 takes control input and does the required task to complete the computation. The state machine 225 contains four major states: retrieve, compose, execute, and transfer/write back state. The behavior of the state machine 225 can be configured using the parameter set by the configure module namely, security parameters, AI application model parameters, etc. The state machine 225 can run inference or back propagation depending on type of flow chosen. It engages extra PLU's for weight update and delta calculation. In various states, the state machine 225 interfaces with the AI solution model parameters memory and the AI security parameters memory via a parameters interface (I/F).

The retrieve state retrieves the input from the local memory of the AI system lane as described with reference to FIG. 1. Returning now to FIG. 2, the retrieve state also may retrieve the partial output from the previous iteration depending on the data dependency of the computation. If security is enabled, the retrieve state also retrieves security related parameters and credentials.

The compose state composes the input to the AI-PLUs of the AI compute engine 115. This depends on the input length, number of parallel hardware present PLU of the engine and also aligns the inputs in the order in which the parallel hardware in the PLU will process the data.

Once the data is composed, the execute state provides the execute signal to one or more sub-blocks/PLUs (S-PLUs and AI-PLUs) to process the input data.

The transfer/write back state writes back the partial results from the PLUs output to a general purpose register or transfers the final output from the PLUs to the local memory.

In one aspect, the AI compute engine block processing engine 205 comprises a general purpose register 250. The general purpose register 250 stores temporary results. The general purpose register 250 is used to store the partial sum coming from the AI-PLU output. These registers are filled by the write back state of the state machine 225.

In one aspect, the AI compute engine block processing engine comprises a control block register 240. The control block register 240 contains the different model parameters required to control the state machine 225. The control block registers 240 are a set of parameters computed on the fly which is used by the state machine 225 to accommodate the input AI solution model with variable size into the specific width parallel hardware present in the AI-PLU hardware. Control registers are used by the state machine 225 to control execution of each state correctly. The control block registers interface with the AI system lane described with reference to FIG. 1 via a model control interface (I/F).

Returning now to FIG. 2, in one aspect, the AI compute engine block processing engine comprises special purpose registers 245. Special purpose registers 245 are wide bus registers used to perform special operations on a data vector at once. The special purpose register 245 may perform the bit manipulation of the input data vector to speed up the alignment of the vector required by the PLU to process the data. The special purpose register 245 may perform shifting/AND/OR/masking/security operations on the large vector of data at once. These manipulations are controlled by the state machine in the compose state. This vector of data from the special purpose is fed into the parallel PLU hardware to compute.

In one aspect, the AI compute engine block comprises an intra block connect bus 255. The intra block connect bus contains the control and data bus required to the communication with different block present within the AI compute engine block. The data path is a high bandwidth bus which supports wide data width data transfer (e.g., 256 bit/512 bit/1024 bit). The control path requires high bandwidth and less data width buses. Local memory is used by the AI compute engine blocks to compute. An interconnect bus within the lanes fills the local memory, which the AI compute engines use to compute the output. Accordingly, this makes the AI compute engine robust and hence does not require the interconnect bus for improved efficiency.

In one aspect, the AI compute engine block comprises AI solution model parameters stored in the AI solution models parameters memory 215 coupled to the processing engine. The state machine 225 reads and writes AI solution model parameters to and from the AI solution models parameters memory via the parameters interface (I/F). Each of the AI solution model parameters contains the configuration data such as input dimension of the model, weight dimension, stride, type of activation, output dimension and other macro parameters used to control the state machine. Thus, each layer could add up to 32 macro parameters.

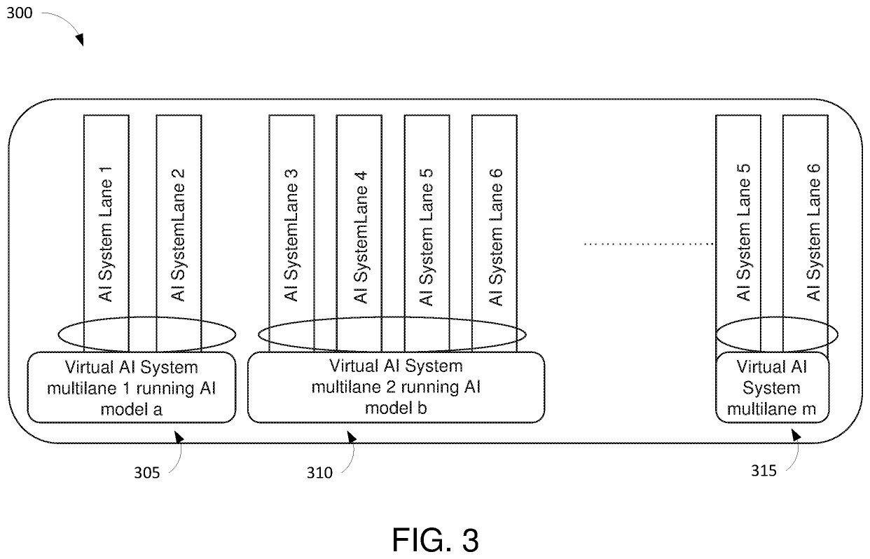

For example, referring to FIG. 3, illustration 300 shows a diagram of a virtual AI system lane created for execution, training and inference of an AI model in accordance with at least one aspect of the present disclosure. A virtual AI system lane may be implemented by first creating one virtual lane. Virtual AI system lanes according to the present disclosure are allocated to process an AI model that meets a given performance criteria and other requirements rather than employing traditional VMs and GPUs allocation to meet AI software framework performance requirements to process an AI model.

Illustration 300 shows that a virtual AI system lane is created to execute the AI model by dynamically allocating one or more AI system lane hardware units based on the size of the AI model and the required execution speed to create a virtual AI system lane. All ideas must be aligned so that it can be compared with GPU virtualization. To create full virtualization, different groups of virtual AI system lanes are configured to execute different models. As shown in FIG. 3, a first virtual AI system multilane 305 comprises two AI system lanes configured to execute AI model “a.” A second virtual AI system multilane 310 comprises four AI system lanes configured to execute AI model “b.” An arbitrary virtual AI system multilane 315 comprises two AI system lanes configured to execute AI model “m.”

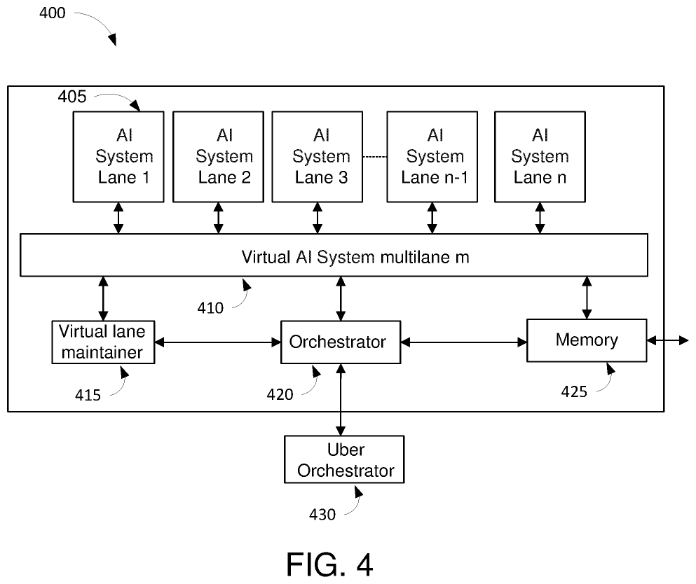

Referring to FIG. 4, illustration 400 is a diagram of a virtual AI system multilane, in accordance with at least one aspect of the present disclosure. Depending on the AI model network structure and performance requirement of the network, the AI model calculation is mapped to multiple lanes 405, etc., in order to create the virtual AI system multilane 410 shown in FIG. 4. Each element of the virtual AI system multilane processing chain is configured via a virtual lane maintainer 415 and a virtual lane composer. For example, the fine grain processing behavior and the structure of the CNN engine (namely, number of layers, filter dimensions, number of filters in each layer, etc.) and the FC engine (namely, number of layers, number of neurons per layer, etc.) can be configured for an AI model execution using the lane composer functions. As described in previous sections of this disclosure, the virtual AI system multilane processing chain can be triggered via a hardware execution sequencer where each current hardware element in the chain triggers the next element (a block, sub block, etc.) in the chain, when it completes the task assigned to it. For instance, if the CNN engine is configured with multiple filters and multiple layers, then the CNN engine completes all the filters and layers before it triggers the next element in the chain i.e., the FC engine.

An initial trigger to execute a given AI model is initiated via a microcontroller, which in turn triggers an uber orchestrator 430, for example. The uber orchestrator triggers corresponding orchestrators 420 of the virtual lanes that participate while in executing the AI model. The memory 425 may be accessed to obtain the desired information for executing the AI model. The hardware execution sequencer components of the participating orchestrators execute the AI system lane processing chains to completion as per configuration. For example, a request may be initiated to train an AI model with a number of epochs, number of samples along with a pointer to location where samples are available. This can be used as a trigger to activate the orchestrator 420 of the participating virtual lane, which in turn sends a multicast trigger to all AI system lane processing lane hardware execution sequencers that are part of the virtual lane.

The multilane architecture disclosed herein provides novel and inventive concepts at least because the parallel processing involved is done using hardware. Hence, scheduling is inherently present in the hardware state machine which looks at the network structure of a model and parallelizes it with given time and power constraints. The scheduling is not done using a software code but is parallelized by the hardware. In contrast, in the GPU/CPU paradigm, parallelism is achieved by software code implementation, parallel hardware and hardware pipeline. In the AI system of the present disclosure, the parallelism is achieved through the hardware state machines, parallel hardware and hardware pipeline. Since the control decisions are mainly taken in hardware, software code execution bottlenecks are removed, thus achieving a pure parallel compute hardware architecture.

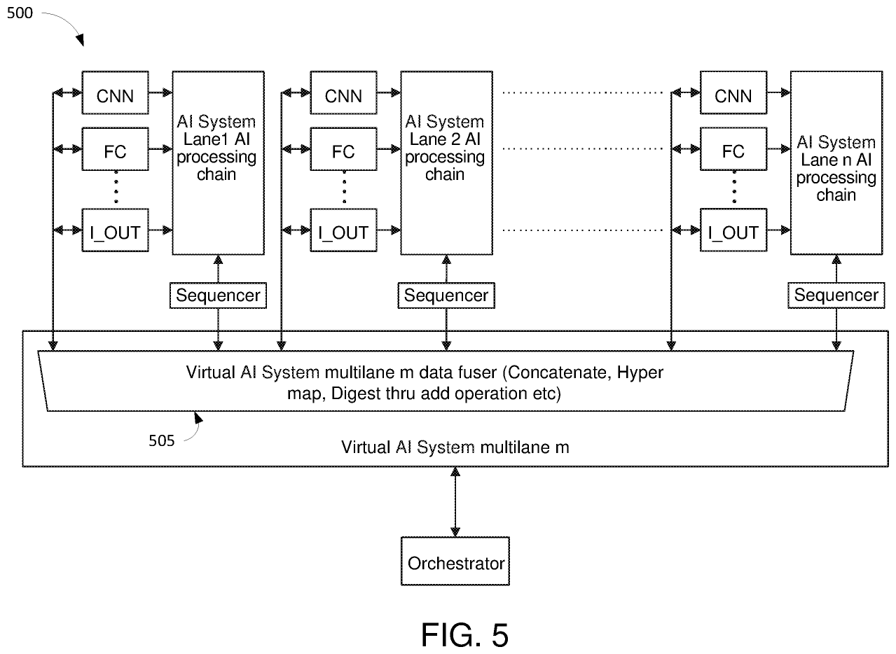

Referring to FIG. 5, illustration 500 is a diagram of a virtual AI system multilane comprising a data fuser 505, in accordance with at least one aspect of the present disclosure. The data fuser 505 is configured to concatenate, hyper map or digest, through operations such as addition, the results received from different AI system lanes that are perfectly aligned in the frequency, time and space domains. If there are L AI system lanes and M filters in an AI model, then the L/M AI model computation can be mapped to each AI system lane within a virtual AI system multilane. Once a layer is computed, all the results are concatenated from all lanes and fed to the next layer computation. Accordingly, a speed up of xL is obtained. The input can be shared to all AI system lanes which are scheduled to work on the AI model. This enables the computation of different AI models at different AI system lanes.

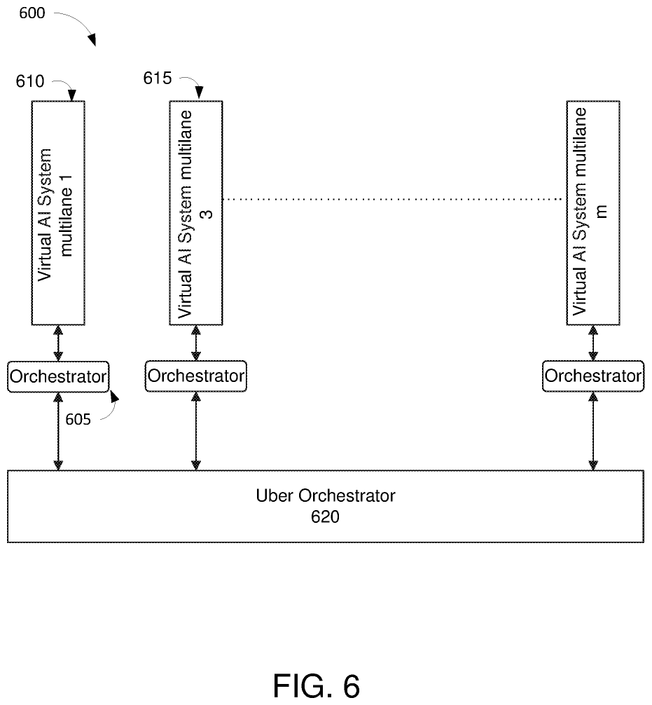

Referring to FIG. 6, illustration 600 is a diagram of a virtual AI system multilane comprising an uber hardware orchestrator 620, in accordance with at least one aspect of the present disclosure. Coupled to the uber orchestrator 620, the AI system lane processing hardware comprises an AI system processing hardware orchestrator 605 to setup and execute the different workloads on the each virtual AI system multilane 610, 615, etc., as well as the AI system lanes within the virtual AI system multilanes. As used hereinbelow, AI system lanes is used to refer to each virtual AI system multilane as well as the AI system lanes within the virtual AI system multilanes. The AI system processing hardware orchestrator 605 operates in a hierarchical fashion. In this sense, each virtual AI system multilane 610, 615, etc., is controlled by an instance of the AI system processing hardware orchestrator 605. An uber hardware AI processing hardware orchestrator 620 is provided to oversee all AI lanes orchestrator instances. All AI system lanes report to the their respective AI processing hardware orchestrator 605 whether they are busy or not. Depending on different criteria of the workload, the AI system processing hardware uber orchestrator 620 will schedule the task to the specific engines in each of the AI system lanes. The AI system processing hardware uber orchestrator 620 comprises the report of all the engines in the AI system lanes that are available to compute and also the engines in the AI system lanes that are busy. The AI system processing hardware uber orchestrator 620 maintains a status table of AI system lanes to indicate whether the corresponding specific hardware of the AI system lane is busy or not.

Discussion of Asynchronous and File System-Based AI Processing Interface Framework

The AI system framework of the present disclosure is a self-contained secure framework designed to run a full AI solution, according to some embodiments. The AI system virtual multi-lane architecture can run many computations in parallel without the need for an instruction set and SDK or CPU driven software AI framework. Rather, the present solution can utilize AI solution configuration data, AI deep learning model network structure, associated input data such as weight, bias set and trigger data. Hence, the AI system framework is exposed as a filesystem interface. The user just needs to drag and drop the above data in the form of files. The AI system will automatically sense the files and run inference or training accordingly. Once the results are generated, it will be available in a result folder with the appropriate time stamp.

The AI system secure framework also provides built-in security measures to the file system based asynchronous interface, consistent with the security features described in Provisional Application Attorney Docket No. Set 1/1403394.00002, U.S. Provisional Application No. 62/801,044, which is again incorporated herein by reference. With this, all configuration, model, input and various command trigger files are first checked for security clearance before being used for running the AI system engines, according to some embodiments. Hence, this provides robust, secure and easy mechanisms to be used in cutting edge (e.g., automotive/IOT etc.) infrastructures. This will thwart any attacks launched via edge technologies (e.g., automotive, IOT, etc.) as botnets for DDOS attacks.

It is believed there is not any such secure as well as asynchronous file system based mechanism for running AI solutions with such ease as described herein.

The present disclosures provide a number of advantages over existing technologies:

1. seamless and secure architecture

2. No SDK, no programming

3. No special interface between host systems and the AI system based module of the present disclosure. The module is exposed to a host as asynchronous as well as file system based interface via SDI/SPI/PCI/USB or via network interface such as Ethernet, wireless. etc.

The AI system of the present disclosure can interact with a host system such as a PC, laptops, server, phone, pad, cameras, lidar systems, radar systems, embedded routers, appliances, etc., via USB, SSD, PCI, SPI, and can present itself as a local transaction (PCI or USB, etc.) based asynchronous system as well as file system interface system. Similarly, the AI system of the present disclosure can also interact with any of the above host systems via network connections such as Ethernet, wireless, etc., and can present itself as a network transaction (e.g., TCP/IP or UDP/IP, etc.) based asynchronous system as well as a file system interface system.

4. As a result, a user can send to an interface one or more asynchronous files/records, namely, config information, model data, input data, and various requests such as trigger request etc., in real-time and in a continuous manner. These data files/records may represent instructions on how to generate an AI solution model or provide data inputs on what type of AI solution model to generate.

5. Moreover, a user in the host can see various responses in the form of asynchronous data files for every request it sends to the interface system (local or network) in a real-time manner. Results may be available as another series of asynchronous real-time responses or files.

6. The module of the present disclosures can perform training and inference in embedded (fog, mist, phone) environments where the host CPU is constrained in terms of processing power as well as energy, especially for training as well as inference without the need for elaborate software AI frameworks.

7. Unlike typical engines that may perform similar functions, the module of the present disclosure has no overhead and is only asynchronous file system event driven, and is therefore highly energy efficient.

Further Details of the Asynchronous AI Framework

Presented herein is a lightweight, highspeed and energy efficient asynchronous and file system based AI processing interface framework. In some aspects, the AI processing interface framework includes the following properties:

a. Lightweight AI processing framework interface without the need for heavy weight Cuda or Tensorflow for efficiency and speed;

b. Platform agnostic (e.g., CUDA, Tensor flow, other half a dozen frameworks) model conversion to multitnenacy virtualized multilane AI processing framework;

c. Using asynchronous request response client server interaction for AI solution/model execution;

d. Automatic local/network attached file system based request, execution, response of AI solution/models interface;

e. Particular interaction with the uber orchestrator, namely:
i. AI execution chain definition preparation and writing;
ii. AI virtual lane creation/selection; and
iii. Slicing model data vertically and horizontally to push across a virtual AI system multilane.

These five properties will be described in more detail, below.

Lightweight AI Processing Framework Interface without the Need for Heavy Weight Cuda or Tensorflow for Efficiency and Speed

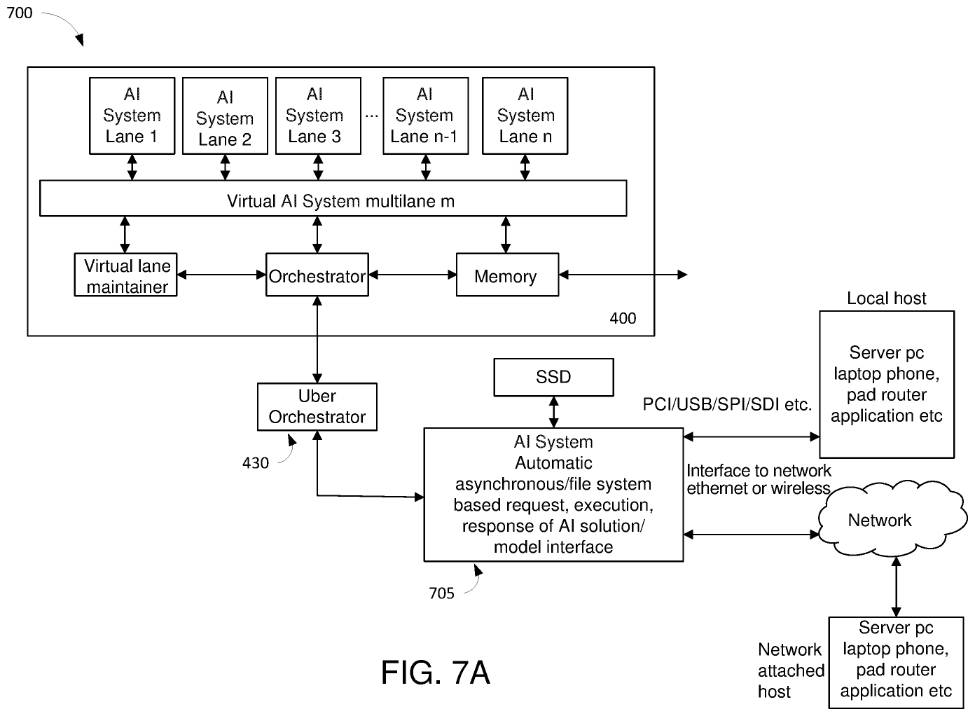

Illustration 700 of FIG. 7A shows a functional block diagram of an AI system with connections to host users in an example of the AI processing framework interface, according to some embodiments. The system includes a Request, Execute and Response (RER) system 705. The system 400 of FIG. 4 is referenced herein. The uber-orchestrator 430 is connected to an AI system asynchronous or file system based RER unit 705. The RER unit 705 can act in an asynchronous capacity and change to a file system capacity and vice versa.

In the asynchronous case:

The AI system RER 705 interacts with a host system such as a PC, laptop, server, phone, pad, cameras, lidar systems, radar systems, embedded routers, appliances, etc., via USB, SSD, PCI, SPI, and can present itself as a local transaction (PCI or USB, etc.) based asynchronous interface system. Similarly, the AI system can also interact with any of the above host systems via network connections such as Ethernet or wireless, etc., and can present itself as a network transaction (TCP/IP or UDP/IP etc.) based asynchronous interface system. As a result, the user can send to the interface one or more asynchronous data, namely, config information, model data, input data, and various requests such as a trigger request, etc. Moreover, the user in the host can see various response data segments for every request it sends to the interface system (local or network) interface.

In the file system case:

The AI system RER 705 may be connected to any local host system such as a PC, laptop, server, phone, pad, cameras, lidar systems, radar systems, embedded routers, appliances, etc., via USB, SSD, PCI, SPI, can present itself as a local file system interface. Similarly, the AI system may be connected to any host via a network such as Ethernet or wireless, etc., and can present itself as a network file system based interface. As a result, the user can drop to the interface one or more files, namely, config information file, model files, input data files, and various request files such as trigger file etc. Moreover, the user in the host can see various response files for every request files it drops into the file system (local or network) interface.

In some embodiments, the AI system RER 705 invokes the uber orchestrator 430, which in turn invokes one or more orchestrators connected to lanes of the AI system, as appropriate (see e.g., FIG. 4), to run all required security & AI processing as described in the required config & trigger data. The RER 705 manages all the independent interface controllers to get input and drive output results. The output is an asynchronous series of data or series of files which can be delivered over the interfaces. If any jobs have to be run, then the host will contact the AI system RER 705 through one of the interfaces and ask it to run the job. In some embodiments, it will need the weight files, AI network configuration files and performance setting files. All the files will be in RER format (e.g., binary) which is easily readable, according to some embodiments. This file will be fetched by the RER and will be saved into the on-chip memory or SSD. It will also instruct the orchestrator. The orchestrator will read the config instructions and orchestrate the execution of the corresponding algorithm on the particular specified lane.

Illustration 750 of FIG. 7B shows an additional viewpoint of particular modules of the asynchronous AI interface system, according to some embodiments. Here, the connections focus on structures that receive the request for the user and process the request. As shown, the user request is entered through the asynchronous interface, which is received by the RER unit 755. The asynchronous interface via the RER unit 755 decodes the incoming asynchronous file/record and invokes the uber orchestrator 430 for fulfilling the requests/responses.

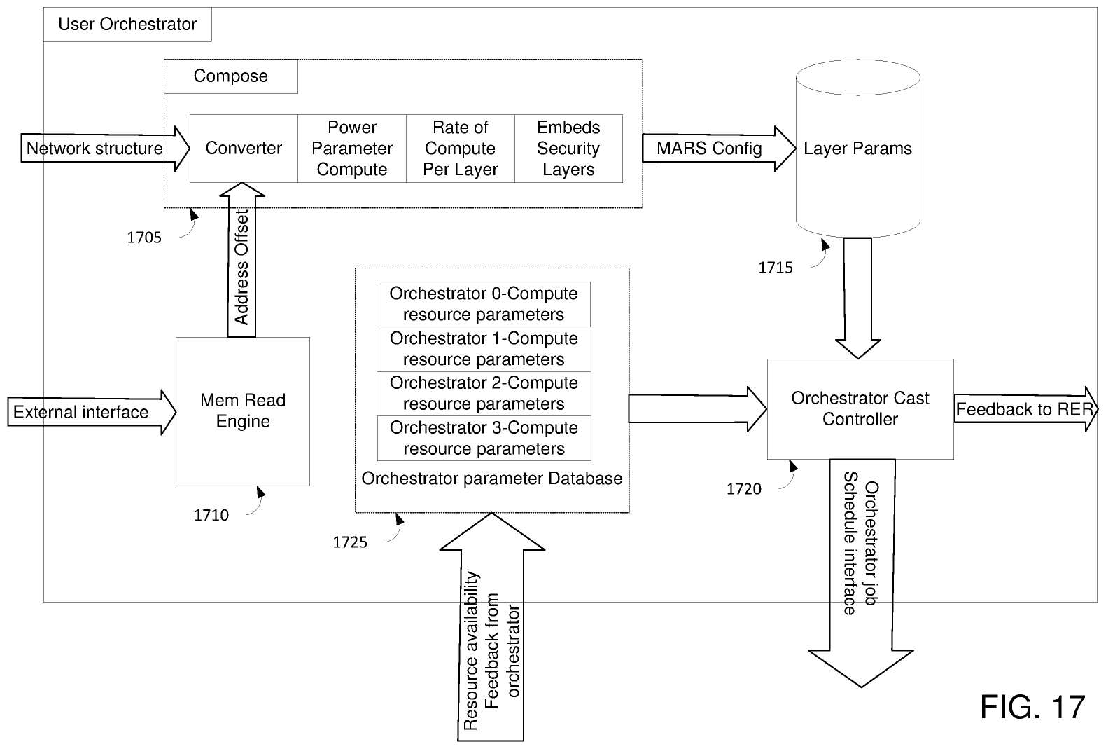

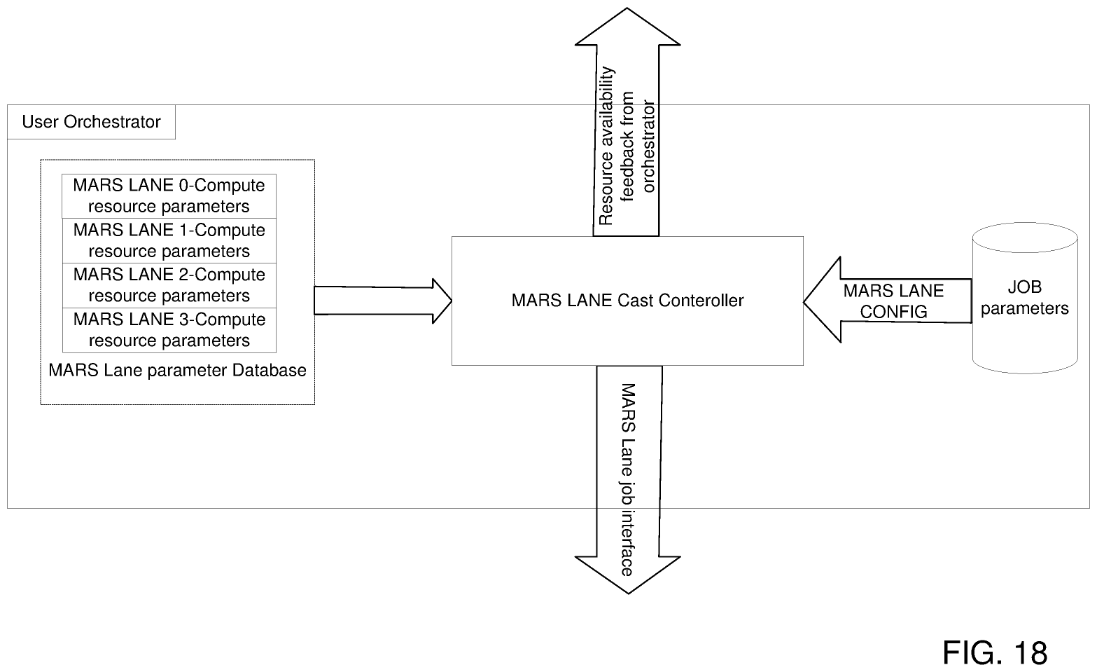

The uber orchestrator 430 interacts with the RER unit 755, which then communicates to one or more orchestrators 420 connected to the various lanes of the AI multilane system, via a formed virtual AI system multilane 410. For example, the uber orchestrator 430, upon receiving the request, per virtual lane basis, works with respective orchestrators 420 to compose and send appropriate execution data and triggers for execution. Upon receiving a completion signal, the uber orchestrator 430 in turn informs the RER unit 755, which then may create an asynchronous file/record with a completion response command to indicate to the user. In some cases, the requests received for definition, allocation, and execution are tagged with appropriate security and trust credentials via the security features disclosed in provisional application (Attorney Docket No. Set 1/1403394.00002 U.S. Provisional Application No. 62/801,044. Additional example details about the uber orchestrator are discussed with respect to FIGS. 17 and 18, described below.

According to some aspects, the AI system runs on a light weight framework. This means there is no need for additional coding. All the efficiency and speed is optimized by the uber orchestrator of the AI system. The network structure and the weight inputs are given to the engine, which depend on the network, structure and requirement input given by the user. For example, if the user gives an aggressive workload, then the orchestrator will use more resources to finish the job.

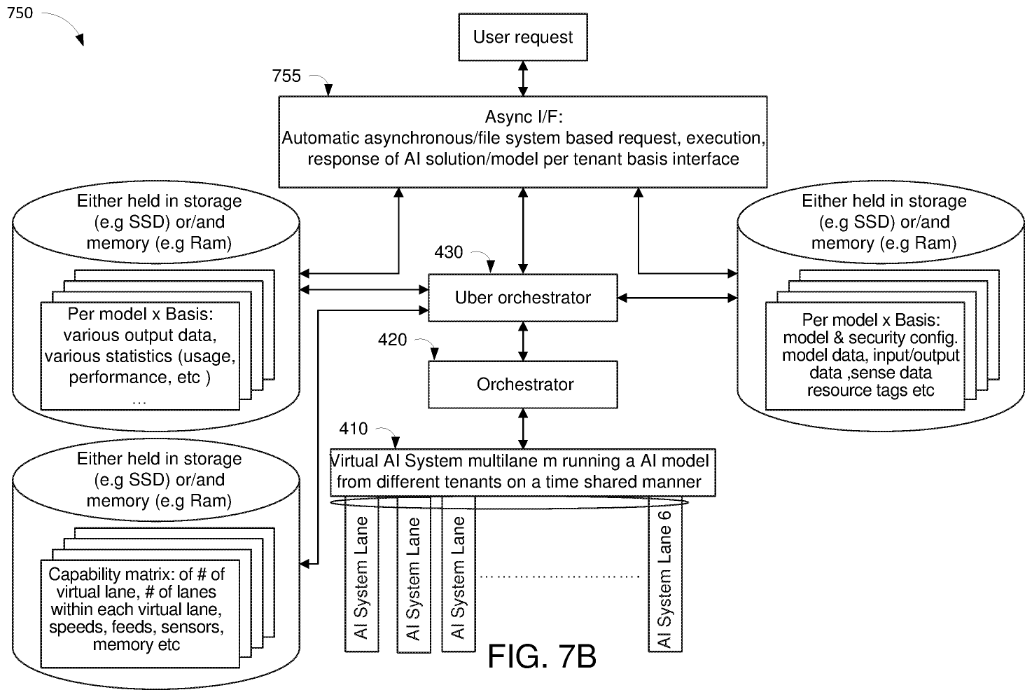

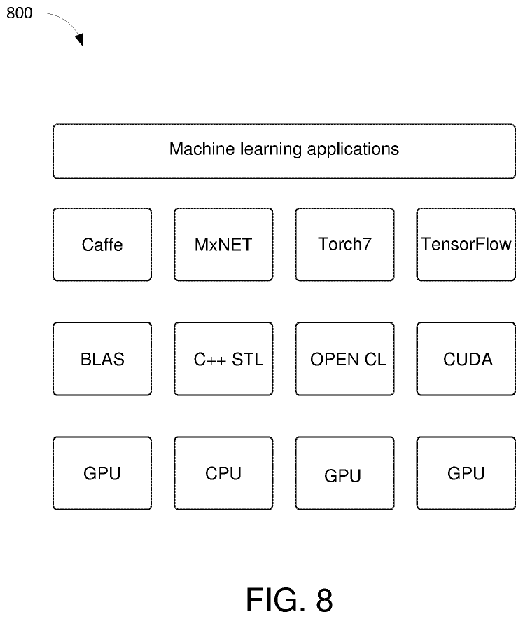

Traditionally, the execution stack for a GPU or CPU is as follows. The machine learning algorithm is represented by one of the frame work such as Caffe, MxNET, Torch7 or TensorFlow. These frameworks convert the numerical computation into data flow graphs. They support computation on hardware like a CPU/GPU. This is done by supporting different kinds of device specific software such as CUDA, OpenCL, BLAS, etc. So these acceleration frameworks take over to accelerate the computation represented by the data flow graphs. Illustration 800 of FIG. 8 is a chart providing a number of examples of machine learning applications. Illustration 900 of FIG. 9 shows an example of how the execution stacks for GPUs and CPUs connect to applications to perform machine learning using conventional architecture.

For example, the CUDA framework will require the domain knowledge such as C and architecture knowledge of GPU's to accelerate it. It also requires a compatible ecosystem such as a host operating system, a compatible CPU, etc., to facilitate the framework. This tends to add a lot of upfront cost to the user.

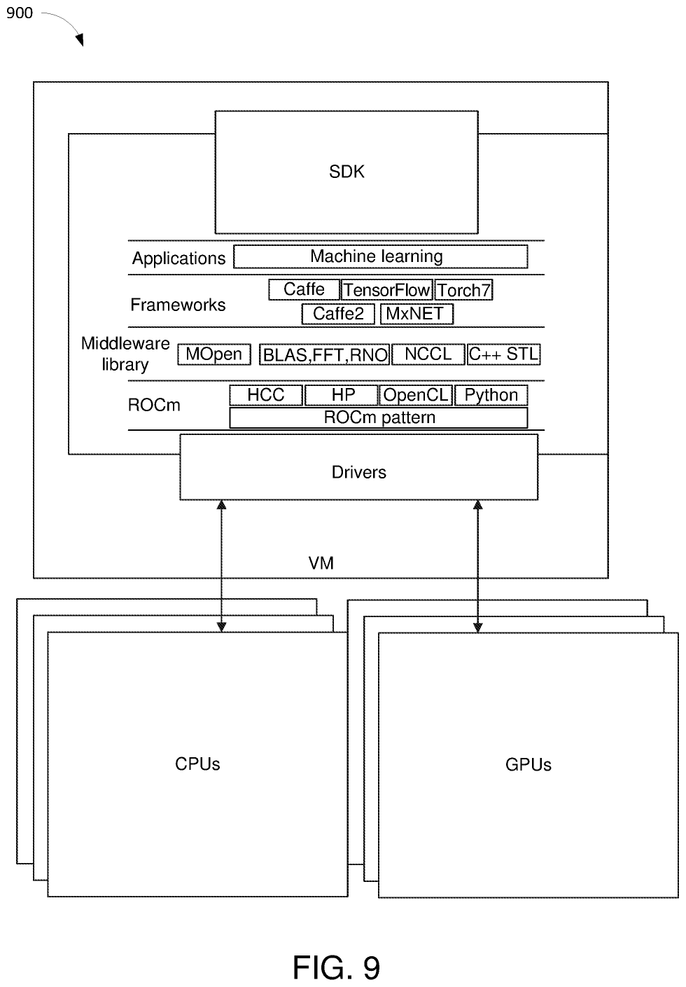

In contrast, the AI system approach of the present disclosure utilizing the RER doesn't require CUDA or some extensive framework to run the AI algorithm on the chip, and generally is solved using a hardware based solution rather than relying on multiple layers of software. The AI solution model network structure will decide the parameter to be set to the AI system configuration. This configuration will guide the orchestrator to parallelize and pipeline the algorithm to run on the lanes of the AI system. The AI system only requires network structure, config, weight, etc. in a text file or binary file format. It will be able to run the algorithms using these inputs. No coding is required. FIG. 10 shows a diagram of the elegant design architecture of the AI system of the present disclosure, utilizing a network structure that connects to the RER interface and the file system view of the user or host. Notice how there are no additional software layers in between that would typically provide a slower processing time to conduct a similar AI solution model solution.

In some embodiments, this may be accomplished in part because the RER module includes multiple reconfigurable look up table driven state machines that are configured to adapt to the AI hardware directly. No software is needed for the state machines to perform their functions that replace all of the functionality that conventional solutions using additional software might require.

For example, there may be multiple state machines that perform the following functions in the RER:

A. Managing the asynchronous interface as described above;

B. Automatic detection of files and interpretation processing;

C. Interaction with the resource manager and the uber orchestrator/orchestrator; and

D. If files are dropped (for example, input data) in a manner that could be continuous and voluminous, then it automatically stores files to its high speed storage attached to it. And then in coordination with the AI hardware, the state machine moves the input data to the respective AI lane hardware for processing memory zones. This enables user entities/other entities using this AI hardware to keep streaming input data asynchronously without concerning with the AI hardware handshake, unlike traditional programming paradigms.

Platform Agnostic (e.g., Cuda, Tensor Flow, Other Half a Dozen Frameworks) Model Conversion to Multitenancy Virtualized Multilane AI Processing Framework

Conventionally, each layer in an AI solution model is represented by the network structure, operation and the weight that fills the network structure. All the software AI frameworks contain an API to represent the network structure and take in input and weight as input of the API. The API will execute the layer computation using the hardware stack available (e.g., GPU, etc.). So there is a lot of translation happening in between. For example, the AI algorithm in tensor flow will be converted to a CUDA code or OpenCL code depending on the GPU or the graphic computer that is available. Also, the data is moved from a host OS to a virtual box OS in case of a guest OS running in a host PC. So all kinds of data handover and control handover happens in stack execution approach, as an example.

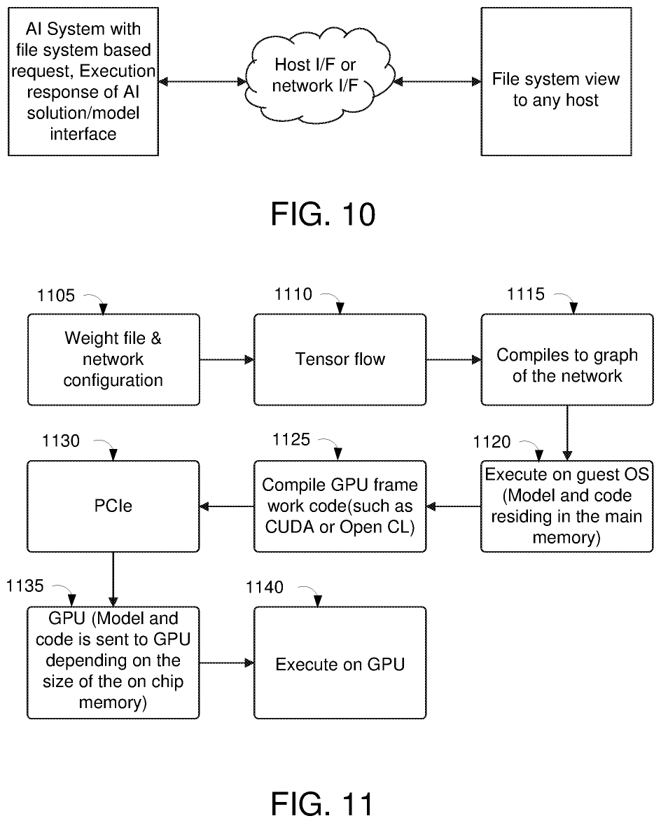

FIG. 11 shows the stack execution flow in typical GPU based systems. At block 1105, the GPU based systems run a host on a guest OS or host OS utilizing a weight file and network configuration. At block 1110, the tensor flow is one of the frameworks used to represent the AI solution model. It is represented in a graph structure. At block 1115, the graph structure code is converted into OpenCL or CUDA code depending on the framework supported by the GPU. This is executed on the guest OS, at block 1120. Then the code is compiled on a GPU framework at block 1125. At block 1135, the data is transferred from the host system to GPU on-chip memory, via PCIe or other similar vehicle, at block 1130. Then the code starts to execute on the GPU, at block 1140. Once the execution is complete, the data is transferred back from the GPU to the host. If the on-chip memory is not enough, then the GPU will ask for the remaining files to complete the run. So if there any communication, then it has to go through all the layers to complete it.

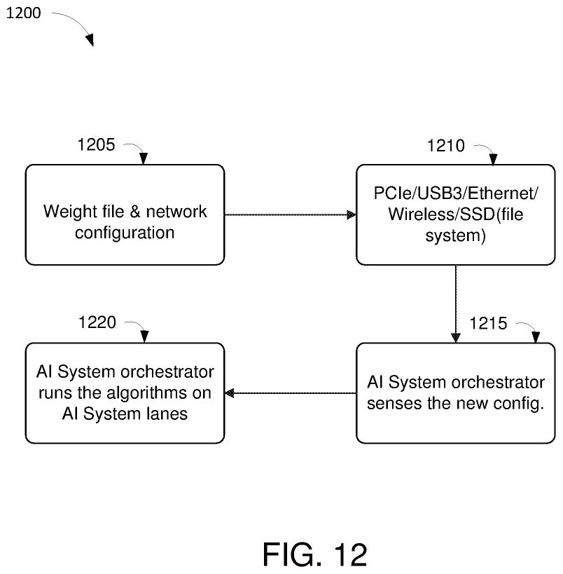

In contrast, in the AI system of the present disclosures, the weight and the network configuration file is directly dropped into to the AI system RER unit that is connected through PCIE, USB, Ethernet, wireless or SSD file transfer (see e.g., FIGS. 7A and 7B). The AI system RER unit will convert the network configuration into necessary config files. The AI system orchestrator will sense it and move the data to on-chip memory and run it and finish the job. FIG. 12 shows the process flow of the AI system. This is in contrast with the traditional process flow of a GPU in FIG. 11. At block 1205, the network configuration is still negotiated using at least a weight file. These may simply be dropped into the RER unit. At block 1210, connection of the system to facilitate user interaction is established using PCIe, USB3, Ethernet, wireless, etc. From here, at block 1215, the AI system orchestrator or uber orchestrator engages the user system and senses the new configuration. Last, at block 1220, the orchestrator runs the algorithms on the AI system multilanes according to any of the above descriptions. Clearly, there are fewer processes that need to occur, creating a much more efficient and streamlined approach.

Using Asynchronous Request Response Client Server Interaction for AI Solution/Model Execution

The AI system of the present disclosure can interact with a host system such as a PC, laptops, server, phone, pad, cameras, lidar systems, radar systems, embedded routers, appliances, etc., via USB, SSD, PCI, SPI and can present itself as a local transaction (PCI or USB, etc.) based asynchronous system as well as a file system interface system. Similarly, the AI system of the present disclosure can also interact with any of the above host systems via network connections such as Ethernet, wireless, etc., and can present itself as a network transaction (e.g., TCP/IP or UDP/IP, etc.) based asynchronous system as well as a file system interface system. As a result, a user can send to an interface one or more asynchronous data or files, namely, config information, model data, input data, and various requests such as trigger request etc., in real-time and in a continuous manner. Moreover, the user in the host can see various response data segments for every request it sends to the interface system (local or network) interface.

For AI Solution/Model execution, the system continuously looks for trigger data, meaning a command or other indication to initiate training of an AI solution model. Once it sees a latest trigger command, it invokes the following steps, referring to some structures in FIG. 7A:

1. Ensures the RER unit can see the config data, model data, input data segments, etc. that was provided asynchronously by a user.

2. Invokes the orchestrator to run the AI system security feature to validate each data segment to pass the trust and security check.

3. If security check passed:
i. It invokes the uber orchestrator of an AI virtual lane, which in turn invokes the orchestrators of each of the AI lanes, to load the config data to the internal memory and in turn also configures appropriate lanes of the AI system, and AI chain templates.
ii. Once the config has passed it, in co-operation with the orchestrator of each lane, the RER unit loads all model data to the internal memory.
iii. Depending on number of input data, segments and availability internally, the system either transfers them in chunks or at a stretch to the internal memory or stores it to the SSD attached to it.

4. If all required data are available and their loading succeeded, the system will ask the orchestrator to send the trigger to the AI engines to execute various AI chains.

5. Once the orchestrator receives an execution completion signal, it in turn sends the completion signal to the interface module.

6. If the input has more input data in the local SSD, it will try to send more data from its SSD to the AI system internal memory execution via the orchestrator. The user from the host or the device interacting to it can continuously send required input data.

7. Steps 4, 5, and 6 can be repeated until all input data are ingested.

8. Once the final completion is received, the AI system may request the orchestrator to fetch appropriate result data, formats them in the acceptable asynchronous format and sends them to the system via asynchronous transaction means (e.g., local PCI or network TCP/IP means).

9. If all the steps are passed and execution is successful, the system creates a response indicating SUCCESS.

10. If any steps above fail, the system creates a FAILED data response with additional data into it.

Automatic Local/Network Attached File System Based Request, Execution, Response (RER) Unit of an AI Solution/Models Interface

Refer again to FIG. 7A for a description of the automatic local/network attached file system based request, execution, response (RER) unit 705 of an AI solution/models interface. The AI system is connected to any local host system such as a PC, laptop, server, phone, pad, cameras, lidar systems, radar systems, embedded routers, appliances, etc., via USB, SSD, PCI, SPI and can present itself as a local transaction (PCI or USB, etc.) based asynchronous system as well as file system interface system. Similarly, the AI system of the present disclosure can also interact with any of the above host system via network connections such as Ethernet, wireless, etc., and can present itself as a network transaction (e.g., TCP/IP or UDP/IP, etc.) based asynchronous system as well as a file system interface system. As a result, a user can send to an interface one or more asynchronous data or files, namely, config information, model data, input data, and various requests such as trigger request etc., in real-time and in a continuous manner. Moreover, the user in the host can see various response data segments for every request it sends to the interface system (local or network) interface.

For AI solution/model execution, the system continuously looks for trigger data. Once it sees a latest trigger data it invokes the following steps, referring to some structures in FIG. 7A:

1. Ensures it can see config data, model data, input data segments, etc. loaded into the system as a record or file.

2. Invokes the orchestrator to run the AI system security feature to validate each data segment to pass the trust and security check.

3. If security check passed:
i. It invokes the orchestrator to load the config data to the internal memory and in turn also configures appropriate lanes of the AI system, and AI chain templates.
ii. Once the config has passed it, in co-operation with orchestrator, it loads all model data to the internal memory.
iii. Depending on number of input data, segments and availability internally, the system either transfers them in chunks or at a stretch to the internal memory or stores it to the SSD attached to it.

4. If all required data are available and their loading succeeded, the system will ask the orchestrator to send the trigger to the AI engines to execute various AI chains.

5. Once the orchestrator receives an execution completion signal, it in turn sends the completion signal to the interface module.

6. If the input has more input data in the local storage (e.g., SSD or similar memory or any other similar storage), it will try to send more data from its local storage to the AI system internal memory execution via the orchestrator. The user from the host or the device interacting to it can continuously send required input data.

7. Steps 4, 5, and 6 can be repeated until all input data are ingested.

8. Once the final completion is received, the AI system may request the orchestrator to fetch appropriate result data, formats them in the acceptable asynchronous format and sends them to the system via asynchronous transaction means (e.g., local PCI or network TCP/IP means).

9. If all the steps are passed and execution is successful, the system creates a response indicating SUCCESS.

10. If any steps above fail, the system creates a FAILED data response with additional data into it.

Description of the Interaction with the Uber Orchestrator

There are three particular interactions with the uber orchestrator relevant to the disclosures herein.

i. AI Execution Chain Definition Preparation and Writing

The AI execution chain definition preparation is done by the uber orchestrator.

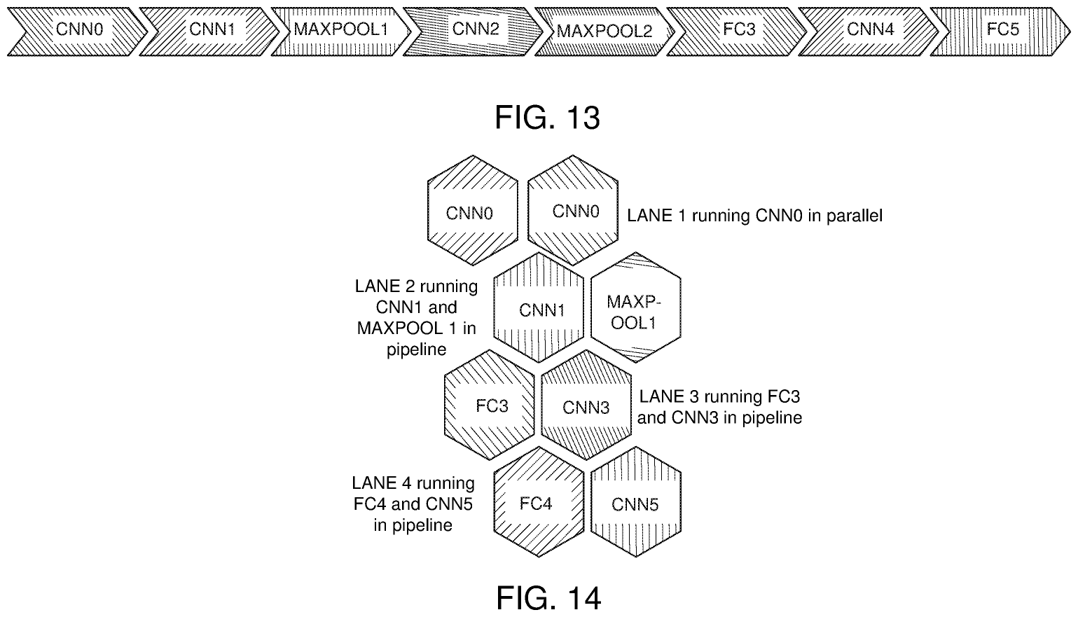

FIG. 13 describes an example of the chain of operation by the uber-orchestrator. Shown are example operations that may be queued up to perform. This chain is dependent on the algorithms and the number of AI system lanes available. This is one example of the AI execution chain described by the uber-orchestrator. The uber orchestrator will parallelize and pipeline the algorithm described in FIG. 13.

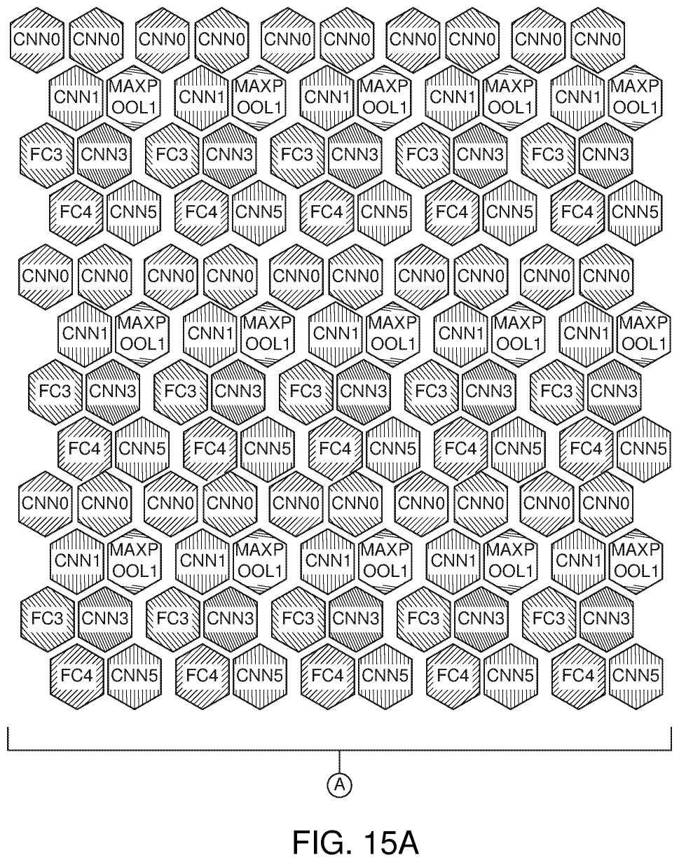

In FIG. 14, an example of the pipelining and parallelizing of the execution flow by the uber-orchestrator is represented. Each of the honeycombs describes an AI-PLU unit in a lane of the AI system. This shows that two AI-PLUs share the CNN0 calculation in LANE 1. After the calculation is completed, the LANE 1 will combine the results and forward it to LANE 2. In LANE 2, one AI-PLU is running the CNN1 and another AI-PLU is running MAXPOOL1. Now, LANE 1 and LANE 2 are running two layers in the pipeline. The data flow is as follows. The LANE 1 will forward to LANE 2 to LANE 3 and so on. So if there are 100 lanes for example, then 25 instances of this algorithm could be run in the pipeline and in parallel.

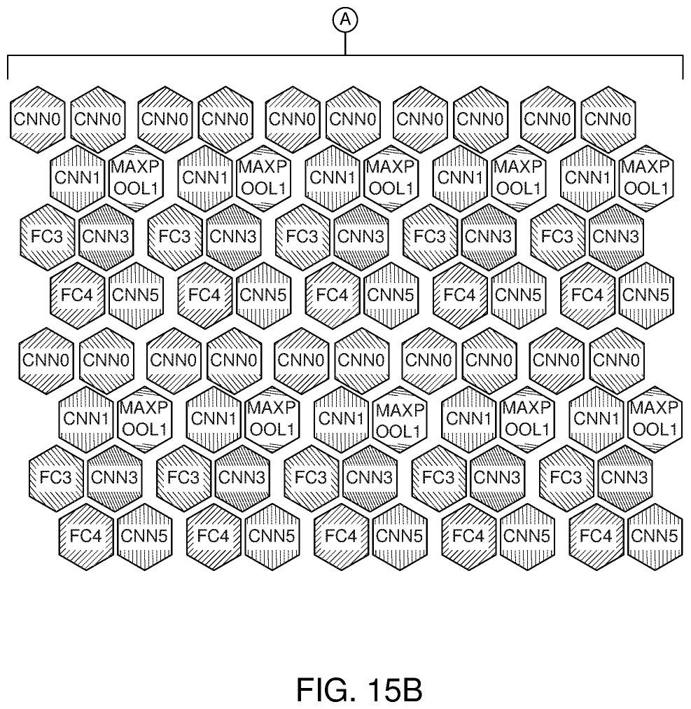

A visualization of the 25 instances running in parallel is shown in FIGS. 15A and 15B. Each of the rows may represent a parallel track of operations, each performed by a lane, while the honeycombs running from left to right represent the operations set up in each pipeline. This may all be coordinated by the uber orchestrator who is able to keep track of the utilization of each lane.

ii. AI Virtual Lane Creation/Selection

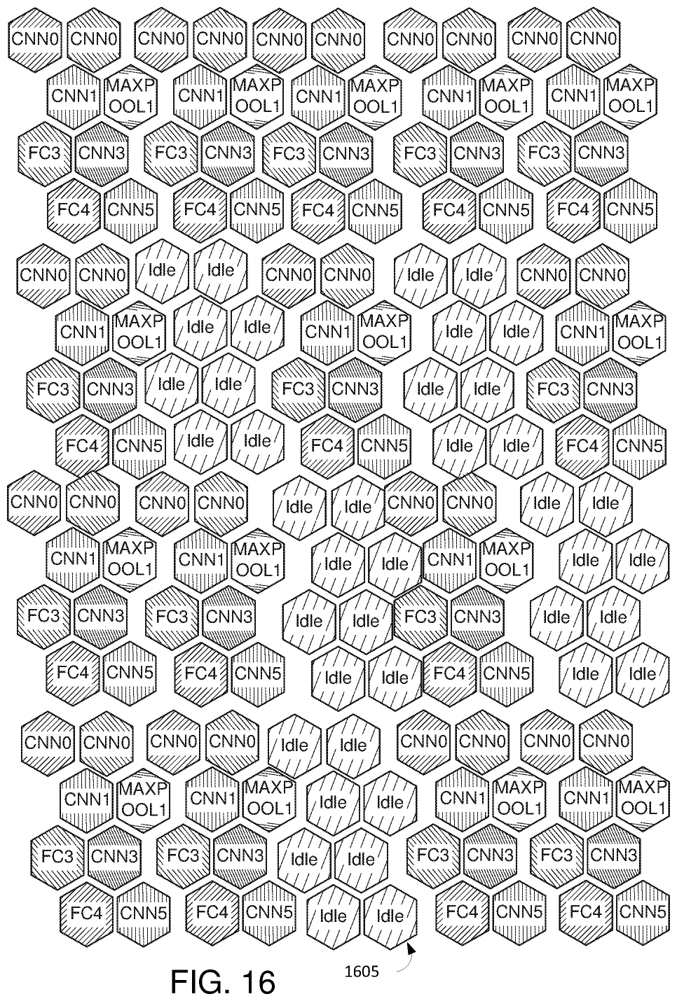

The uber orchestrator creates the virtual lanes and gives them the chain of instructions to execute. In the above example, it grouped four lanes to solve one algorithm. Meaning, it created 4 virtual lanes and selected them to work in a pipeline. Since there are 96 more lanes available, assuming there are 100 lanes, the uber orchestrator can create and group 24 more instances of hardware to work in parallel. Once the assigned job is completed, the uber-orchestrator will free those lanes. It could also keep some lanes idle, too, depending on the power envelope. FIG. 16 provides an example that gives the idea of some lanes sitting idle at certain periods of time, as shown in the idle honeycombs 1605 for example.

iii. Slicing Model Data Vertically and Horizontally to Push Across a Virtual Lane of the AI System

The model is divided by the orchestrator depending on the layer and filter within the layer. Since the above work flow is in parallel, the work can be divided across the lanes and assigned to each to finish the job. If there is any data dependency between two layers or within a layer, then those outputs will be combined and moved to the next layer of execution. See FIGS. 1-6, which describe further details of how other portions of the pipeline data flow are invoked.

FIGS. 17 and 18 describe further details about the orchestrator and uber orchestrator, according to some embodiments.

Referring to FIG. 17, further details about the uber orchestrator are shown, according to some aspects. Here, the uber orchestrator takes the network structure and converts it to the hardware parameters understood by the AI system lanes, using the compose engine blocks 1705. While doing the conversion, additional parameters are added such as rate of compute is calculated, depending on the power and time requirement of the user. Simultaneously, the data is read from the external interface using a memory read engine 1710 and stored onto to the onboard memory which will be used by the AI system lane during execution. The uber orchestrator cast controller 1720 will use AI layer compute parameters from a layer parameters database 1715 and the orchestrator parameter database 1725 to cast a layer operation into an individual orchestrator. AI layer compute parameters will contains rate of computer (this is dependent on power envelope and time to complete), and other parameters that control the AI system lane to execute the AI layer computation. An orchestrator parameter database 1725 will contain the information regarding the availability of the resources for each of the current orchestrators. Depending on the completion, it reports to the RER unit. The orchestrator cast controller 1720 may repeat its operations for each individual orchestrator, for as many individual lanes that are deemed necessary to complete the given task. This allows the uber orchestrator to cause the AI system to carry out tasks both pipelined serially and run operations in parallel.

Referring to FIG. 18, further details about how one orchestrator operates is shown, according to some aspects. As described above, an orchestrator may govern one or more lanes and ultimately governs a set of lanes to form a virtual multilane for performing one set of tasks, and receives instructions from the uber orchestrator. Each orchestrator includes an AI system lane cast controller 1805 to control its particular lane. It also includes an AI lane parameter database 1810 that tracks each lane within its purview. The orchestrator takes the job parameters 1815 from the uber orchestrator. The orchestrator checks the AI system lane availability from its database 1810 and then casts the computation to the available lane. When casting, the AI system lane cast controller 1805 will find the input, output sources for the AI system lane by checking the data dependency on the jobs params database 1815. The lane maintainer will maintain the lanes running and report to the orchestrator regarding the availability of the resource in the AI system lane. The AI system lane cast controller 1805 will then decide the number of computes to be utilized in the AI system lane using the rate of compute parameter from the uber orchestrator.

Example Implementation

The following is one example of an AI CNN command file providing an inference definition, indicating a number of lanes the AI CNN wants to use. For each lane, the command file data provides the definition of the AI CNN model, such as the number of layers of the CNN, number of parameters per layer, and other associated information. The following shows the structure of data used:

number of lanes

Per Lane Params

number of params per layer
number of layers
src input addr offset
result dest addr offset
burst size
number of cnn model memory ports
memory select port
model memory offset
number of bursts
.
.
.
Per Layer parameters (repeats for each layer)

CNN_filter_dim;
CNN_nos_depth;
CNN_nos_filter;
CNN_input_dim;
CNN_stride;
CNN_padding;
CNN_junk_data_shift;
CNN_lane_junk_data;
CNN_nos_computes;
CNN_nos_stall_cycles;
layer_enables;
MXPL_stride;
MXPL_padding;
MXPL_input_dim;
MXPL_filter_dim;
MXPL_nos_computes;
MXPL_nos_stall_cycles;
MXPL_junk_data_shift;
MXPL_mask;

The following shows example data in the asynchronous file/record associated with the above structure:

00000001

00000013

00000002

00001000

00004000

00000001

00000004

00000001

00100000

0000001b

00000002

00120000

00000001

00000003

00200000

0000001b

00000004

00220000

00000001

00000005

00000003

00000020

0000001f

00000001

00000000

00000000

00000000

00000008

00000003

0000000f

00000002

00000000

0000001b

00000003

00000010

As shown, above provides extreme flexibility in defining an AI solution model and its requirements in terms of how many lanes it wants to use, what is the model definition of the AI solution (for example, the above shows CNN and MAX pool, etc.).

Shown below is one example of an AI FC command file providing the inference definition, indicating a number of lanes an AI FC wants to use. For each lane, it provides the definition of the AI FC model, namely, the number of layers of FC, number of parameters per layer, and other associated information. The following shows the structure of data used:

Number of Lanes
For each Lane

Number of Layers
INPUT SIZE
L1 Neuron Size
L2 Neuron Size
L3 Neuron Size
INPUT ADDR

BIAS ADDR

WGT ADDR
SOFT MAX SIZE

TOP N PICKS

The following shows example data in the asynchronous file/record associated with the above structure:

00000002

00000003

00000400

00000180

000000c0

0000000a

c0004000

c0008000

c000c000

0000000a

00000003

00000003

00000400

00000180

000000c0

0000000a

c0006000

c000a000

c000e000

0000000a

00000003

As shown, the above provides extreme flexibility in defining an AI solution and its requirements in terms of how many lanes it wants to use, and what is the model definition of the AI solution (for example above is showing for FC).

If a user wants to run an AI solution comprising CNN, MAX POOL and FC, all the user needs to do is provide the above two asynchronous files/records to achieve the goal or combine the above into one asynchronous file/record and send to the RER unit. No extra software is required, and no additional formatting is needed.

In order to load various configuration and model data (e.g., input, weight and bias, etc.) related to a given AI solution, the user can create another asynchronous load definition file/record indicating the number of model data files the user is providing, which model type (CNN or FC, etc.) the that data belongs to, and tag of the model data file/record itself. Here is an example load definition structure:

Number of load definitions

| | |
|---|---|
| CNN BIAS DATA | file tag of the associated data |
| CNN WEIGHT DATA | file tag of the associated data |
| FC BIAS DATA | file tag of the associated data |
| FC WEIGHT DATA | file tag of the associated data |

Here is an example model load definition file/record with the example definition corresponding to the example AI solution definition created above:

4

| | |
|---|---|
| 0014ff00 | cnn_bias_data file tag |
| 0018ff00 | cnn_weight_data file tag |
| 0014ff01 | fc_bias_data file tag |
| 0018ff01 | fc_weight_data file tag |

The user can then send the asynchronous data file containing the actual data corresponding to the above tag data types and tags respectively.

Finally, in order to run an AI solution model with the above FC and CNN definition and model data loaded, the user would simply send a trigger file, containing trigger commands to activate the process. For example,

Cnn_trigger

FC_Trigger

Example data associated in the file is as follows:

00000011

00000110

The RER unit may intercept the above trigger and in turn sends the instructions to the uber orchestrator to compose and trigger appropriate internal execution.

While several forms have been illustrated and described, it is not the intention of the applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

The foregoing detailed description has set forth various forms of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skilled in the art in light of this disclosure. In addition, those skilled in the art will appreciate that the mechanisms of the subject matter described herein are capable of being distributed as one or more program products in a variety of forms and that an illustrative form of the subject matter described herein applies regardless of the particular type of signal-bearing medium used to actually carry out the distribution.

Instructions used to program logic to perform various disclosed aspects can be stored within a memory in the system, such as DRAM, cache, flash memory, or other storage. Furthermore, the instructions can be distributed via a network or by way of other computer-readable media. Thus a machine-readable medium may include any mechanism for storing or transmitting information in a form readable by a machine (e.g., a computer), but is not limited to, floppy diskettes, optical disks, CD-ROMs, magneto-optical disks, ROM, RAM, EPROM, EEPROM, magnetic or optical cards, flash memory, or tangible, machine-readable storage used in the transmission of information over the Internet via electrical, optical, acoustical, or other forms of propagated signals (e.g., carrier waves, infrared signals, digital signals). Accordingly, the non-transitory computer-readable medium includes any type of tangible machine-readable medium suitable for storing or transmitting electronic instructions or information in a form readable by a machine (e.g., a computer).

As used in any aspect herein, the term “control circuit” may refer to, for example, hardwired circuitry, programmable circuitry (e.g., a computer processor comprising one or more individual instruction processing cores, processing unit, processor, microcontroller, microcontroller unit, controller, DSP, PLD, programmable logic array (PLA), or FPGA), state machine circuitry, firmware that stores instructions executed by programmable circuitry, and any combination thereof. The control circuit may, collectively or individually, be embodied as circuitry that forms part of a larger system, for example, an integrated circuit, an application-specific integrated circuit (ASIC), a system on-chip (SoC), desktop computers, laptop computers, tablet computers, servers, smart phones, etc. Accordingly, as used herein, “control circuit” includes, but is not limited to, electrical circuitry having at least one discrete electrical circuit, electrical circuitry having at least one integrated circuit, electrical circuitry having at least one application-specific integrated circuit, electrical circuitry forming a general-purpose computing device configured by a computer program (e.g., a general-purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

As used in any aspect herein, the term “logic” may refer to an app, software, firmware, and/or circuitry configured to perform any of the aforementioned operations. Software may be embodied as a software package, code, instructions, instruction sets, and/or data recorded on non-transitory computer-readable storage medium. Firmware may be embodied as code, instructions, instruction sets, and/or data that are hard-coded (e.g., non-volatile) in memory devices.

As used in any aspect herein, the terms “component,” “system,” “module,” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet-switched network. The communication devices may be capable of communicating with each other using a selected packet-switched network communications protocol. One example communications protocol may include an Ethernet communications protocol which may be capable permitting communication using a Transmission Control Protocol/IP. The Ethernet protocol may comply or be compatible with the Ethernet standard published by the Institute of Electrical and Electronics Engineers (IEEE) titled “IEEE 802.3 Standard,” published in December 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum, titled “ATM-MPLS Network Interworking 2.0,” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the foregoing disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components, inactive-state components, and/or standby-state components, unless context requires otherwise.

Those skilled in the art will recognize that, in general, terms used herein, and especially in the appended claims (e.g., bodies of the appended claims), are generally intended as “open” terms (e.g., the term “including” should be interpreted as “including, but not limited to”; the term “having” should be interpreted as “having at least”; the term “includes” should be interpreted as “includes, but is not limited to”). It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations or two or more recitations). Furthermore, in those instances where a convention analogous to “at least one of A, B, and C, etc.” is used, in general, such a construction is intended in the sense that one having skill in the art would understand the convention (e.g., “a system having at least one of A, B, and C” would include, but not be limited to, systems that have A alone, B alone, C alone, A and B together, A and C together, B and C together, and/or A, B, and C together). In those instances where a convention analogous to “at least one of A, B, or C, etc.” is used, in general, such a construction is intended in the sense that one having skill in the art would understand the convention (e.g., “a system having at least one of A, B, or C” would include, but not be limited to, systems that have A alone, B alone, C alone, A and B together, A and C together, B and C together, and/or A, B, and C together). It will be further understood by those within the art that typically a disjunctive word and/or phrase presenting two or more alternative terms, whether in the description, claims, or drawings, should be understood to contemplate the possibilities of including one of the terms, either of the terms, or both terms, unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures, or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials are not inconsistent herewith. As such, and to the extent necessary, the disclosure as explicitly set forth herein supersedes any conflicting material incorporated herein by reference. Any material, or portion thereof, that is said to be incorporated by reference herein but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

### EXAMPLES

Various aspects of the subject matter described herein are set out in the following numbered examples:

Example 1. An artificial intelligence (AI) system comprising: a request, execution, and response (RER) module comprising an asynchronous user interface that is configured to receive a request from a user to train an AI solution model using at least one request file or record as input, wherein the request file or record is in a text and/or binary format; an uber orchestrator module communicatively coupled to the RER module and configured to: determine resource needs to optimally train the AI solution model based on the request from the user received at the RER module; and provide instructions for activating one or more lanes in an AI multilane system to train the AI solution model; and the one or more lanes in the AI multilane system communicatively coupled to the uber orchestrator and configured to: receive the instructions from the uber orchestrator to train the AI solution model; and operate in parallel with one another during training of the AI solution model in accordance with the instructions.

Example 2. The AI system of Example 1, wherein the RER module is further configured to receive one or more requests from the user in a drag and drop format.

Example 3. The AI system of Example 1 or 2, wherein the RER module is further configured to receive multiple requests simultaneously from multiples users to train same or different AI solution models.

Example 4. The AI system of any of Examples 1 to 3, further comprising, for each lane of the one or more lanes, an orchestrator communicatively coupled to the uber orchestrator and their respective lane, wherein each orchestrator is configured to process the instructions from the uber orchestrator, and activate power to their respective lane minimally necessary to perform the solution or training or inference of the AI solution model.

Example 5. The AI system of any of Examples 1 to 4, wherein the RER module and the uber orchestrator are platform agnostic, such that the RER module and the uber orchestrator do not utilize software to translate, compile, or interpret the AI solution model training or inference or decision requests from the user.

Example 6. The AI system of any of Examples 1 to 5, wherein the uber orchestrator is further configured to initiate a security check of the request from the user before providing instructions for activating the one or more lanes.

Example 7. The AI system of any of Examples 1 to 6, wherein the uber orchestrator is further configured to develop an execution chain sequence that coordinates an order in which the one or more lanes in the AI multilane system are to execute AI solution model training or inference or decision operations in order to develop a solution to the AI solution model.

Example 8. The AI system of Example 7, wherein developing the execution chain sequence comprises orchestrating at least some of the lanes in the AI multilane system to execute operations in parallel to one another.

Example 9. The AI system of any of Examples 1 to 8, wherein the uber orchestrator is further configured to group a subset of the one or more lanes into a virtual AI lane configured to perform at least one AI solution model algorithm collectively.

Example 10. The AI system of any of Examples 1 to 9, wherein the RER module comprises a plurality of reconfigurable look up table driven state machines configured to communicate directly with hardware of the AI system.

Example 11. The AI system of any of Examples 1 to 10, wherein the plurality of state machines comprises a state machine configured to manage the asynchronous interface.

Example 12. The AI system of any of Examples 1 to 11, wherein the plurality of state machines comprises a state machine configured to automatically detect input data files or records and perform interpretation processing.

Example 13. The AI system of any of Examples 1 to 12, wherein the plurality of state machines comprises a state machine configured to interact with the uber orchestrator.

Example 14. The AI system of any of Examples 1 to 13, wherein the plurality of state machines comprises a state machine configured to automatically store streaming input data files or records that are received in a continuous streaming manner.

Example 15. The AI system of any of Examples 1 to 14, wherein the plurality of state machines comprises a state machine configured to automatically send, in coordination with the uber orchestrator and/or orchestrator, the stored input data to an internal memory of an appropriate AI lane of an AI virtual multilane system, in a flow controlled manner.

Example 15. A method of an artificial intelligence (AI) system, the method comprising: receiving, by a request, execution, and response (RER) module of the AI system comprising an asynchronous user interface, an asynchronous request from a user to train an AI solution model using at least one request file or record as input, wherein the request file or record is in a text and/or binary format; determining, by an uber orchestrator module communicatively coupled to the RER module, resource needs to optimally train the AI solution model based on the request from the user received at the RER module; providing, by the uber orchestrator module, instructions for activating one or more lanes in an AI multilane system to train the AI solution model; receiving, by the one or more lanes in the AI multilane system communicatively coupled to the uber orchestrator, the instructions from the uber orchestrator to train the AI solution model; and operating, by the one or more lanes in the AI multilane system, in parallel with one another during training of the AI solution model in accordance with the instructions.

What is claimed is:

1. An artificial intelligence (AI) system comprising:
a request, execution, and response (RER) module comprising an asynchronous user interface that is configured to receive a request from a user to train an AI solution model using at least one request file or record as input, wherein the request file or record is in a text and/or binary format;
an uber orchestrator module communicatively coupled to the RER module and configured to:
determine resource needs to optimally train the AI solution model based on the request from the user received at the RER module; and
provide instructions for activating one or more lanes in an AI multilane system to train the AI solution model; and
the one or more lanes in the AI multilane system communicatively coupled to the uber orchestrator and configured to:
receive the instructions from the uber orchestrator to train the AI solution model; and
operate in parallel with one another during training of the AI solution model in accordance with the instructions.

2. The AI system of claim 1, wherein the RER module is further configured to receive one or more requests from the user in a drag and drop format.

3. The AI system of claim 1, wherein the RER module is further configured to receive multiple requests simultaneously from multiples users to train same or different AI solution models.

4. The AI system of claim 1, further comprising, for at least one of the one or more lanes, an orchestrator communicatively coupled to the uber orchestrator and its respective at least one of the one or more lanes, wherein each orchestrator is configured to process the instructions from the uber orchestrator, and activate power to their respective at least one or more lanes minimally necessary to perform the solution or training or inference of the AI solution model.

5. The AI system of claim 1, wherein the RER module and the uber orchestrator are platform agnostic, such that the RER module and the uber orchestrator do not utilize software to translate, compile, or interpret the AI solution model training or inference or decision requests from the user.

6. The AI system of claim 1, wherein the uber orchestrator is further configured to initiate a security check of the request from the user before providing instructions for activating the one or more lanes.

7. The AI system of claim 1, wherein the uber orchestrator is further configured to develop an execution chain sequence that coordinates an order in which the one or more lanes in the AI multilane system are to execute AI solution model training or inference or decision operations in order to develop a solution to the AI solution model.

8. The AI system of claim 7, wherein developing the execution chain sequence comprises orchestrating at least some of the lanes in the AI multilane system to execute operations in parallel to one another.

9. The AI system of claim 1, wherein the uber orchestrator is further configured to group a subset of the one or more lanes into a virtual AI lane configured to perform at least one AI solution model algorithm collectively.

10. The AI system of claim 1, wherein the RER module comprises a plurality of reconfigurable look up table driven state machines configured to communicate directly with hardware of the AI system.

11. The AI system of claim 10, wherein the plurality of state machines comprises a state machine configured to manage the asynchronous interface.

12. The AI system of claim 10, wherein the plurality of state machines comprises a state machine configured to automatically detect input data files or records and perform interpretation processing.

13. The AI system of claim 10, wherein the plurality of state machines comprises a state machine configured to interact with the uber orchestrator.

14. The AI system of claim 10, wherein the plurality of state machines comprises a state machine configured to automatically store streaming input data files or records that are received in a continuous streaming manner.

15. The AI system of claim 10, wherein the plurality of state machines comprises a state machine configured to automatically send, in coordination with the uber orchestrator and/or orchestrator, the stored input data to an internal memory of an appropriate AI lane of an AI virtual multilane system, in a flow controlled manner.

16. A method of an artificial intelligence (AI) system, the method comprising:
receiving, by a request, execution, and response (RER) module of the AI system comprising an asynchronous user interface, an asynchronous request from a user to train an AI solution model using at least one request file or record as input, wherein the request file or record is in a text and/or binary format;
determining, by an uber orchestrator module communicatively coupled to the RER module, resource needs to optimally train the AI solution model based on the request from the user received at the RER module;
providing, by the uber orchestrator module, instructions for activating one or more lanes in an AI multilane system to train the AI solution model;
receiving, by the one or more lanes in the AI multilane system communicatively coupled to the uber orchestrator, the instructions from the uber orchestrator to train the AI solution model; and
operating, by the one or more lanes in the AI multilane system, in parallel with one another during training of the AI solution model in accordance with the instructions.

17. The method of claim 16, further comprising receiving, by the RER module, one or more requests from the user in a drag and drop format.

18. The method of claim 16, further comprising receiving, by the RER module, multiple requests simultaneously from multiples users to train same or different AI solution models.

19. The method of claim 1, further comprising processing, by an orchestrator coupled to the uber orchestrator and one or more lanes, instructions from the uber orchestrator; and activating power to the at least one or more lanes minimally necessary to perform the solution or training or inference of the AI solution model.

20. The method of claim 1, wherein the RER module and the uber orchestrator are platform agnostic, such that the RER module and the uber orchestrator do not utilize software to translate, compile, or interpret the AI solution model training or inference or decision requests from the user.
